(19) United States
(12) Patent Application Publication
(10) Pub. No.: US 2014/0037956 A1
(43) Pub. Date: Feb. 6, 2014

(54) HIGH VOLTAGE HIGH TEMPERATURE HEATER CABLES, CONNECTORS, AND INSULATIONS

(71) Applicant: Umesh Kumar Sopory, San Jose, CA (US)

(72) Inventor: Umesh Kumar Sopory, San Jose, CA (US)

(21) Appl. No.: 13/952,575

(22) Filed: Jul. 26, 2013

Related U.S. Application Data
(60) Provisional application No. 61/678,578, filed on Aug. 1, 2012.
(60) Provisional application No. 61/801,854, filed on Mar. 15, 2013.

(51) Int. Cl. H01B 7/29; H01B 7/04

(52) U.S. Cl. CPC H01B 7/292; H01B 7/04
USPC 428/368; 174/102 R; 174/120 C; 174/120 R; 428/394; 428/391; 428/384; 428/381

(57) ABSTRACT

A high temperature, high voltage cable having at least one multi-strand conductor whose resistance is controlled by tightness or looseness of pitch. Also, a high temperature, high voltage cable having at least one layer of ceramifiable polymer, and at least one layer of mica/glass. Also, a high temperature, high voltage cable including at least one layer of non-conductive inorganic material, and at least one layer of mica/glass tape. Also, a high temperature, high voltage sleeve having at least one layer of ceramifiable polymer and at least one layer of mica/glass. Also, a high temperature, high voltage sleeve including at least one layer of non-conductive inorganic material and at least one layer of mica/glass. Also a heating cable having at least one layer of mica/glass and at least one layer of thermally conductive and electrically insulating inorganic materials. Also a flexible heating cable including at least one stranded conductor and at least one layer of flexible mica/glass tape that is coated with thermally conductive and electrically insulating material.

The following non-provisional patent application claims priority to provisional patent application 61/678,578, filed on Aug. 1, 2012 and provisional patent application 61/801,854 filed Mar. 15, 2013 to the present inventor.

### TECHNICAL FIELD

The present invention relates generally to heating devices, and particularly to heating cables.

### BACKGROUND ART

As drilling for exploration and extraction of oil and gas becomes more far-ranging, there are increased challenges for production crews. Increasingly, off-shore drilling and some very deep on-shore drilling are used to access previously inaccessible areas, which require special equipment. In particular, it may be necessary to heat some of the equipment and/or pipes or material itself like rock, soil, etc. in order to efficiently extract the material. As with most liquids, the viscosity of crude oil varies with temperature, and becomes less viscous at higher temperatures. It becomes easier to keep the material flowing in a pipe when the material viscosity is lower, and therefore it may be necessary to heat the material, or the pipes themselves, to keep the material flowing properly.

In order to accomplish this proper flow of material, it is sometimes necessary to provide heat at very high temperatures, greater than 600° c. Some of these applications require products that can generate high power, e.g. Watts, at these high temperatures. Since deposits tend to be deep in the ground, perhaps tens of thousands of feet deep, high input voltage is required to be able to generate adequate power at these depths in a safe and efficient manner. That means the package for a heating device needs to have a tough and usable insulation package with good dielectric properties at both high temperatures, and high voltages.

It is also a concern that the process to manufacture these heaters needs to be relatively simple and cost effective

Presently, there are several systems available that can withstand high voltages, such as polymer jacketed hi-voltage cables, but these can not withstand high temperatures. Other heating systems like sect (referring to skin effect heating system) can be very long but cannot be operated at high temps. These heaters may be constant wattage parallel circuit cut-to length heating devices or constant wattage series heating devices. Other designs like mineral insulated (MI) cables may utilize mineral insulation like MgO (magnesium oxide) powder as an insulator but this product is generally too stiff and may not be usable at very high voltages because of inadequate di-electric properties. MgO is hygroscopic and tends to pick up moisture and thus lose its dielectric properties unless thoroughly dried.

Flexibility of the heater cables may also be an issue, as the cable may need to bend as it follows the pipeline through the ground. There may be a minimum bending radius that is desirable for such cables, that present cables may be incapable of producing.

Thus, there is a great need for heating cables which can be used at high temperatures, which can generate high power at very high voltages, which can be fabricated in very long lengths needed for the deep under-ground heating applications, and which are flexible enough to bend as necessary for the application.

### DISCLOSURE OF INVENTION

Briefly, one preferred embodiment of the present invention is a high temperature, high voltage cable having at least one multi-strand conductor whose resistance is controlled by tightness or looseness of pitch. Another preferred embodiment is a high temperature, high voltage cable having at least one conductor, at least one layer of ceramifiable polymer, and at least one layer of mica/glass. Another preferred embodiment is a high temperature, high voltage cable including at least one conductor, at least one layer of non-conductive inorganic material, and at least one layer of mica/glass tape. Yet another preferred embodiment is a high temperature, high voltage sleeve having at least one layer of ceramifiable polymer and at least one layer of mica/glass. Another preferred embodiment is a high temperature, high voltage sleeve including at least one layer of non-conductive inorganic material and at least one layer of mica/glass. Another preferred embodiment is a heating cable having at least one conductor, at least one layer of mica/glass and at least one layer of thermally conductive and electrically insulating inorganic materials. Yet another preferred embodiment is a flexible heating cable including at least one stranded conductor and at least one layer of flexible mica/glass tape that is coated with thermally conductive and electrically insulating material.

An advantage of the present invention is that it presents heater cables which can withstand very high voltages in the range of 100-25,000 volts.

Another advantage of the present invention is that it presents heater cables which can withstand very high temperatures, greater than 600° c.

And another advantage of the present invention is that it provides heater cables which have much greater flexibility than prior high temperature cables.

A further advantage of the present invention is that it can be manufactured easily and efficiently.

A yet further advantage of the present invention is that it can produce very high resistances and thus be used at very high voltages while maintaining good flexibility.

Another advantage of the present invention is that it provides heater cables which have coatings of inorganic materials which prevent electrical leakage between layer through interstices as in densified layers of powdered materials in MgO, e.g..

Yet another advantage of the present invention is that sleeves of high voltage and heat resistant materials can be used to fortify conventional wires to provide them with heat and high voltage protection.

A further advantage of the present invention is that sleeves of high voltage and heat resistant materials can be used to repair splices and joints of wires.

Another advantage of these sleeves is to extend circuit lengths by joining two lengths and adequately insulate the joint for high temperature and high voltage use.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows a detail of a cable showing the degree of twist over a unit length;

FIG. 2 shows a side view of a single strand of a multi-strand conductor demonstrating pitch;

FIG. 3 shows a cross-sectional view of a first embodiment of the present invention;

FIG. 4 shows a cross-sectional view of a second embodiment of the present invention;

FIG. 5 shows a cross-sectional view of a third embodiment of the present invention;

FIG. 6 shows a cross-sectional view of a fourth embodiment of the present invention;

FIG. 7 shows a cross-sectional view of a fifth embodiment of the present invention;

FIG. 8 shows a cross-sectional view of a sixth embodiment of the present invention;

FIG. 9 shows a cross-sectional view of a seventh embodiment of the present invention;

FIG. 10 shows a cross-sectional view of an eighth embodiment of the present invention;

FIG. 11 shows a cross-sectional view of a ninth embodiment of the present invention;

FIG. 12 shows a cross-sectional view of a tenth embodiment of the present invention;

FIG. 13 shows a cross-sectional view of a three-phase system embodiment of the present invention;

FIG. 14 shows a cross-sectional view of an insulation sleeve embodiment of the present invention;

FIG. 15 shows a longitudinal cross-sectional view of an insulation sleeve embodiment of the present invention;

FIG. 16 shows a longitudinal cross-sectional view of a shaped insulation sleeve embodiment of the present invention;

FIG. 17 shows a cross-sectional view of a shaped insulation sleeve embodiment of the present invention; and

FIG. 18 shows a longitudinal cross-sectional view of a shaped insulation sleeve embodiment of the present invention.

### DETAILED DESCRIPTION OF THE PREFERRED EMBODIMENTS

The present invention is a high voltage, high temperature heating cable, which will be referred to generally by the reference number 10, and thus shall be referred to as 10, and its general elements referred to by 2-digit numbers. There are a number of preferred embodiments which shall be referred to successively by 3-digit numbers such as “100”, “200”, etc., although the layers which are of material common to several embodiments will be referred to by the more general 2-digit element number.

In general, a conductor having a resistance (ohms/ft.) is wrapped in insulation and encased in a sheath. The sheath may be of metal which can act as a return path to complete the electrical circuit. Thus, when voltage is applied, power is generated according to the relationship of p=i²r (power equals current squared times resistance). Thus, the configuration of the conductor, insulation and return wire or sheath and how they are put together are all variables that need to have proper characteristics in order to perform well in rigorous environments.

There are several aspects to the present invention, which provide advantages over the prior art, concerning these important variables.

First, concerning the current carrying conductor, the most used product in the field today is mineral insulation (mi) cable in various sizes and wattage ranges. This generally uses a solid conductor, and therefore the cable is very stiff and not very flexible.

In general, a central conductor having a certain resistance per foot carries a certain voltage and generates heat according to the p=i²r heating formula.

The present invention preferably, but not necessarily, uses multiple conductors of smaller diameter which together to produce a composite resistance with the same or higher than the single conductor in MI on a per foot basis. This configuration makes the cable less rigid, and more flexible.

In addition, the multiple conductors may be twisted together in a spiral configuration. This spiral may be thought of as having similar qualities to the threads on a machine screw, including the “pitch”, which may be understood as equivalent to the “threads/inch” measurement of wood screws. If the spiral is viewed from the side, it appears as a “waveform” with peaks and valleys. Pitch is defined as the number or fraction of consecutive peaks per unit of length, such as inch or foot. This pitch varies with the diameter of the cable. In the industry, pitch is spoken of as being “tight” or “loose”. A tight pitch would have more twists/inch or foot, and a loose pitch has less.

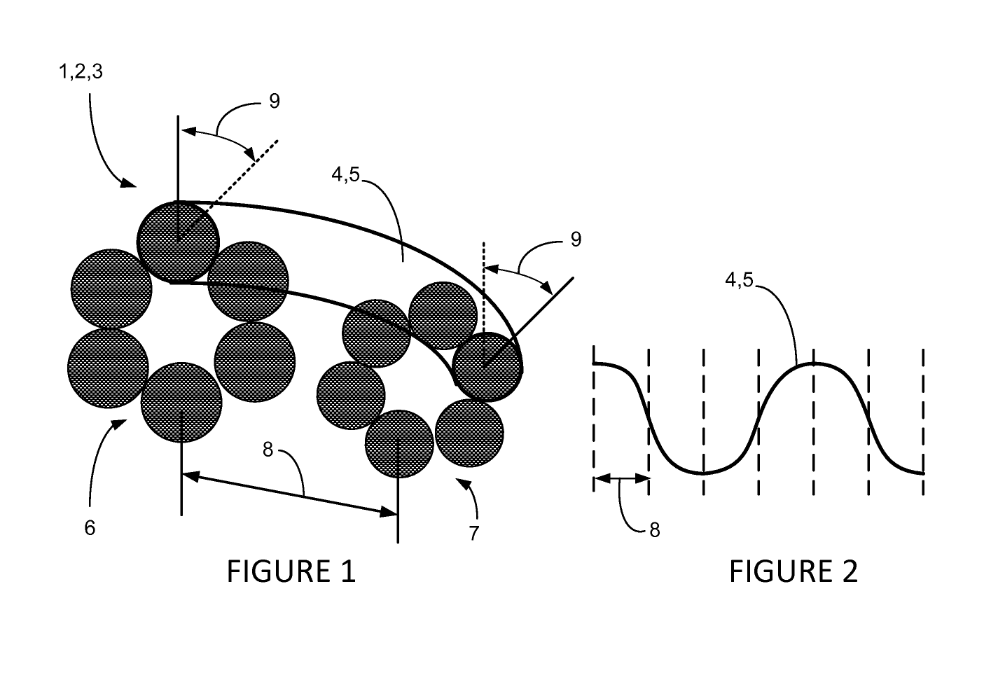

For aid in a general discussion of pitch, FIG. 1 shows a detail view of a multi-strand conductor 1, which is a twisted multi-strand cable 2, having multiple strands 3, in this example having six individual strands 4. A particular strand 5 is shown in two positions. A first position 6 and a second position 7 are shown at the ends of a particular unit length 8. Over this unit length 8, the strand 5 moves to an angular displacement 9, and thus the twist of this strand 5 and the cable 2 can be described in terms of degrees of twist per unit length.

As discussed above, a single strand 5 of the cable 2 is shown from a side view in FIG. 2, which shows the approximate “waveform” of the cable 2, which is used in calculating the pitch of the cable's twist. The unit lengths 8 are shown. In this picture, pitch is demonstrated by the number or fraction of consecutive peaks per unit of length, inch or foot.

By changing the pitch of twisted cables, resistance per lineal foot of cable can be changed. By winding more cable material into a tight pitch, resistance increases, thus with the same equivalent diameter of twisted conductor, different power outputs can be produced, since resistance per lineal foot changes with the change in pitch.

However, pitch also affects the flexibility of a cable. Tighter pitch makes finished cable stiffer with higher resistance, whereas looser pitch makes the cable with less twist, lower resistance and more flexibility. There may be a trade-off between flexibility and power production.

For the application of providing heat to underground cables which must follow bends and turns of pipes, it is desirable that a certain minimum amount of flexibility is provided. Prior cables, such as mi cables, and cables providing tight pitch, are relatively inflexible.

When calculating pitch, the method involves taking the equivalent diameter of the bundle of wires, and then if this diameter is multiplied ×8, this results in a bundle having a “tight pitch”, thus being stiffer. If the equivalent diameter of bundle of wires is multiplied ×14, this results in a bundle having “loose pitch”, and are therefore more flexible.

For example, if a bundle of 6 wires having equivalent diameters of 0.125:

For “tight pitch”: 0.125″×8=1.0″ (tight-stiff)

For “loose pitch”: 0.125″×14=1.75″ (loose-flexible)

Therefore pitch range for this set of conditions is: 1″-1.75″

The present invention utilizes a pitch which that can be used at high voltage, while maintaining good flexibility in this preferred range. This configuration of pitch and flexibility is the product of considerable experience and experimentation, and is assertedly novel in itself. Also, the present inventor has found that different size conductors may be twisted together or combinations of different alloys with different thermal and/or electrical properties may be twisted together to produce unique wattage responses.

Twisting of conductors may also be utilized to include sensor wires in the cable bundle to generate and access live data.

Concerning the variable of insulation, prior product MI cables generally utilize MgO (magnesium oxide powder) as an insulator around a central conductor with a certain resistance/ft. Generally, the package is put inside a metallic tube and whole assembly is drawn or swaged such that the powder compacts around the conductor. The conductor and the sheath are also drawn such that the thickness of the tube and the conductor is reduced to meet resistance and diameter specs. With powder used as a filler and in thicknesses required to be effective as a dielectric, the heater becomes very rigid and difficult to bend.

In contrast to these conventional prior cables, some embodiments of the present invention use mica/glass tape composite wrapped around the central conductor to use as insulation. Depending upon the design requirements, the present invention may use layers of glass tape and layers of mica tape to required thickness to achieve the proper dielectric properties for the cable. By changing these layers, these cables can be configured to operate at very high voltages. Also since the tapes are flexible the whole cable becomes flexible even when inside a metal sheath.

MgO and other metal oxides (alone or as powder mixtures or as pre-fab ceramics rings, tubes etc.) can be configured as a small layer inside and/or outside the mica/glass package encased in a metal tube, slightly drawn or swaged to compress and compact the powder and mica/glass package. This gives rugged yet relatively flexible heating cable that can be used at very high temperatures, and very high voltages.

Another embodiment of the present invention uses layers of flexible coatings of ceramifiable polymers, including ceramifiable silicones, pre ceramic polymers, ceramifiable silazanes on conductor and/or layers in-between or outside of mica/glass insulation package. This can boost dielectric properties at lower temperatures, and adds to dielectric properties of the total composite at higher temperatures.

Thus, improved insulation used on a single or multi-strand conductors in combination or separate insulation packages can provide enhanced thermal, dielectric and mechanical properties for the cable not provided by any other system available

Ceramifiable polymers may be loosely defined as organic polymers which solidify at high temperatures to produce refractory ceramics. These may be extruded on to the conductor and then mica/glass layers wrapped on the conductor/silicone composite as described above. Silicone may also be extruded or laminated on glass or mica tape and then the resulting tape wrapped on the conductor or mica/glass composite as appropriate. An important advantage of putting a silicone layer on glass or mica tape is that it fills up the air voids thereby increasing the dielectric properties of the insulation without major change in thickness.

Embodiments of the present invention use sheath material which may be metal or alloy tube as appropriate for the application. The sheath can also be a metal corrugated hose for flexibility especially when package does not have to be drawn or swaged.

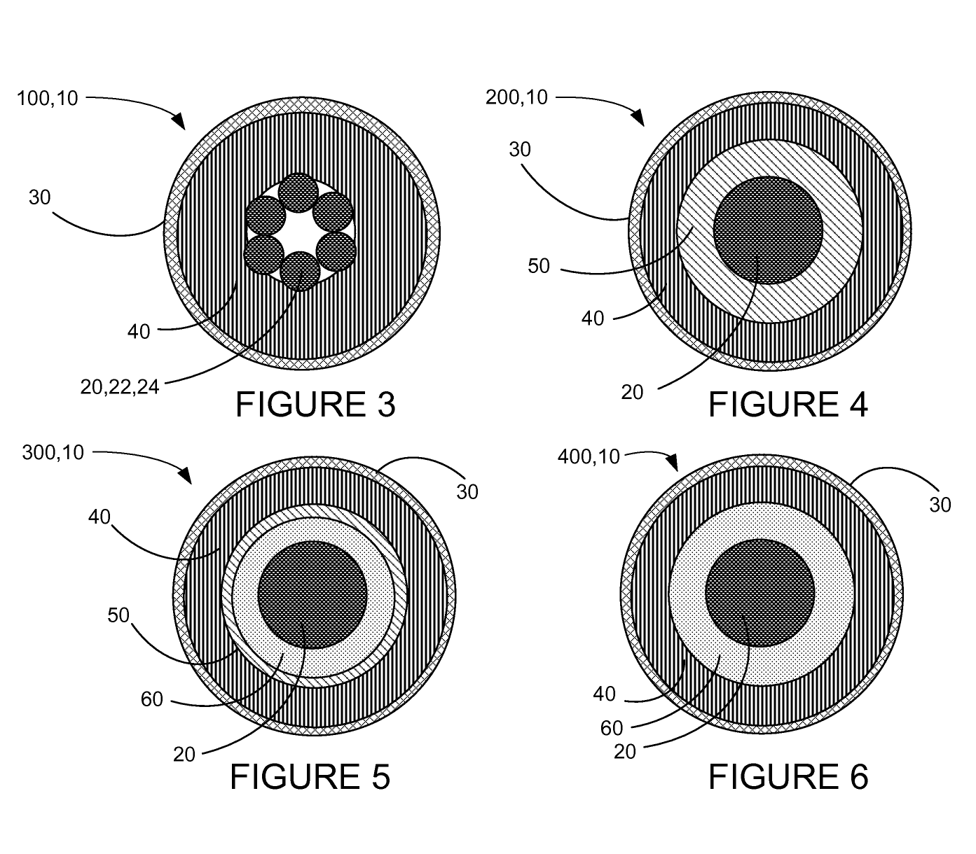

FIG. 3 shows a cross-section of a first embodiment 100 of the present heater cable 10. This embodiment 100 includes a central conductor 20, which may be a multi-strand conductor 22 or a single conductor, and further may be a twisted multi-strand conductor 24. Six strands are depicted in this figure, but it should be understood that this is subject to much variation. The number of strands is preferred to be in the range of 2 to 20 strands, but there may be more. A concentric layer or a number of layers of glass/mica insulator 40 surrounds the conductor 20. These layers of glass/mica insulator 40 preferably include layers of glass tape and layers of mica tape, which are wound around the central conductor 20. A metal sheath 30 encloses these layers to complete the embodiment 100.

FIG. 4 shows a cross-section of a second embodiment 200 of the present heater cable 10. This embodiment 200 includes a central conductor 20, which again may be a twisted multi-strand conductor, which is not shown in the following figures, but will be understood to be an option in this and in all the following embodiments. A concentric layer of ceramifiable polymer 50 surrounds the conductor 20, which in turn is surrounded by a layer of glass/mica insulator 40. A metal sheath 30 encloses these layers to complete the embodiment 200.

It will be understood that ceramifiable polymers will include ceramifiable silicone, pre-ceramic polymers and ceramifiable silazanes.

FIG. 5 shows a cross-section of a third embodiment 300 of the present heater cable 10. This embodiment 300 includes a central conductor 20, which again may be a multi-strand conductor. A concentric layer of MgO or non-conductive inorganic material 60 is surrounded by ceramifiable polymer 50, which in turn is surrounded by a layer of glass/mica insulator 40. A metal sheath 30 encloses these layers to complete the embodiment 300. It will be understood that non-conductive inorganic materials 60 include ceramic, glass and alloys which include, but are not limited to Al₂O₃, TiO₂, SiO₂, B₂O₃, MgO, and BeO, BN, Zirconia, Macor(glass-ceramic), AlN.BN-AlN composite, Alumina-Silica and Yttrium oxide.

FIG. 6 shows a cross-section of a fourth embodiment 400 of the present heater cable 10. This embodiment 400 includes a central conductor 20, which again may be a multi-strand conductor. A concentric layer of MgO or non-conductive inorganic materials 60 is surrounded by a layer of glass/mica insulator 40. A metal sheath 30 encloses these layers to complete the embodiment 400.

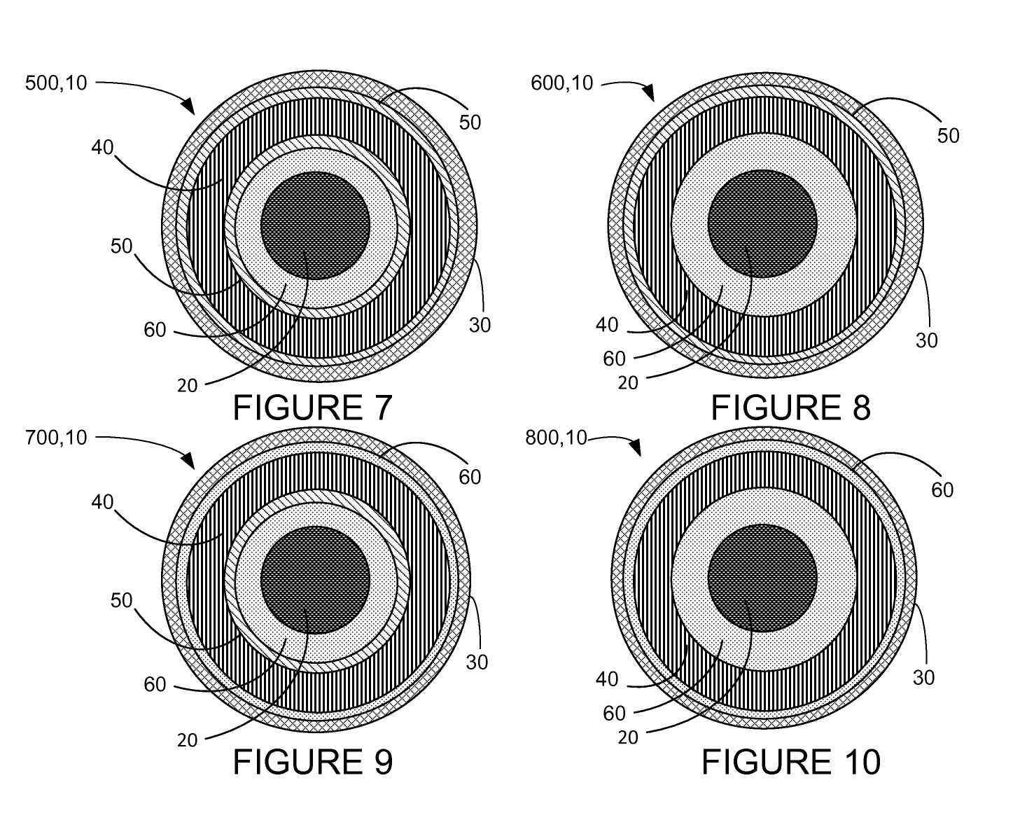

It is also possible that ceramifiable polymers may be used as an inside layer or an outside layer or both. FIG. 7 shows a representative embodiment 500 of this type, in which the same layers of a central conductor 20, concentric layer of MgO or other non-conductive inorganic materials 60, which can include ceramic powders, a concentric layer of ceramifiable polymer 50, a concentric layer of glass/mica insulator 40, and an added outer layer of ceramifiable polymer 50, are enclosed in a metal sheath 30 to complete the embodiment 500.

FIG. 8 shows another representative embodiment 600 of this type, in which the same layers of a central conductor 20, concentric layer of MgO or other non-conductive inorganic material 60, such as ceramic powders, a concentric layer of glass/mica insulator 40, and an added outer layer of ceramifiable polymer 50 are enclosed in a metal sheath 30 to complete the embodiment 600.

In a similar manner, it is also possible that MgO or other non-conductive inorganic powders may be used as an inside layer or an outside layer or both. FIG. 9 shows a representative embodiment 700 of this type, in which the same layers of a central conductor 20, concentric layer of MgO or other non-conductive inorganic material 60 such as ceramic powders, a concentric layer of ceramifiable polymer 50, a concentric layer of glass/mica insulator 40, and an added outer layer of MgO or other non-conductive inorganic material 60 such as ceramic powders, are enclosed in a metal sheath 30 to complete the embodiment 700.

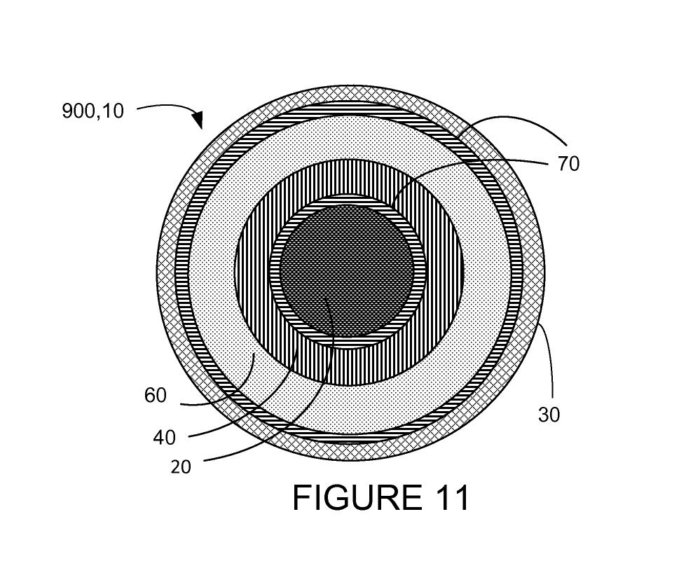

FIG. 10 shows another representative embodiment 800 of this type, in which the same layers of a central conductor 20, concentric layer of MgO or other non-conductive inorganic material 60 such as ceramic powders, a concentric layer of glass/mica insulator 40, and an added outer layer of MgO or other non-conductive inorganic material 60 such as ceramic powders, are enclosed in a metal sheath 30 to complete the embodiment 800.

Layers of semi-conductive material may also be included in the structure of the cables. These semi-conductive layers may be extruded on to the substrates or coated via dip coating or sputtering on to substrates. The coating materials may be conductive polymers, conductive ceramics and/or combination of the two and deposited on the surfaces to be coated. Conductive polymers may be intrinsically conductive and/or made conductive via mixing with substances including, but not limited to CB, graphite, conductive ceramics like NBO, TiO, CrO₂, Ti₂O₃, VO, V₂O₃, and iron oxide. Barium titanate may also be used as a semi-conductive layer.

FIG. 11 shows another representative embodiment 900, in which a central conductor 20, is surrounded by a layer of semi-conductor material 70, a concentric layer of glass/mica insulator 40, a concentric layer of MgO or other non-conductive inorganic material 60 such as ceramic powders, and a second layer of semi-conductor material 70, which are then enclosed in a metal sheath 30 to complete the embodiment 900.

It should be understood that there could be variations that include only one or the other of these semi-conductor layers, and that other configurations of these layers are intended to be included in this invention. Also, it should be understood that there could be variations in the number of individual material layers and relative position of the layers in the composite.

It is also possible that one or more of the layers be made of positive temperature coefficient (PTC) material, negative temperature coefficient (NTC) material, or zero temperature coefficient (ZTC) material.

MgO and other inorganic powders when compressed by swaging are relatively good electric insulators but are not good at high voltages. This is because of leakage, which occurs through interstices in the resulting construction of solid particles that are compressed together. Also, the process is more cumbersome and requires capitol-intensive swaging and compressing equipment. However, the resulting construction is very rugged.

It has been found that it is very effective to make use of coatings of inorganic materials which are coated onto various components of the construction and which may be repeated at various stages of the construction, if desired. These coatings tend to provide a more continuous layer of di-electric material than can be produced by compressed powder. These coatings thus produce better high voltage performance. Coatings of the substrates may be applied by the relatively simple processes already known in the coating art like dip-coating, extrusion coating, spray coating, lamination, brush coating, sputtering and/or evaporation films, followed by processing to dry and cure the coating as required by the materials of choice and process.

As in the previous discussion, the conductor may be stranded or solid construction, which may then be coated with high temperature refractory coatings like CP 3015-WH from Aremco Co. The choice of coatings is dictated by the adhesion to substrate, thickness, temperature, capability and voltage response, among other considerations.

Whether the conductor is coated or not, other substrates may be coated with high temperature refractory coatings to increase the thermal and voltage performance. For example, glass tape or quartz, high temperature glass, ceramic tape, etc. After winding on the conductor may be coated with 634-AS-1 from Aremco Co. By dip coating or other means as mentioned above, dried and followed by layers of mica, glass, etc., as the design requires.

These coatings may be several mils thick and may be applied several times as needed or physically possible. The purpose is to increase the dielectric properties of the layered package for various applications. These coatings may be based on titanium diboride, alumina, alumina-silica, BN, SI, yttrium oxide, zirconium oxide, MgO and any other ceramic or refractory that can be made into a stable slurry that is coatable.

As referred to above, many variations are possible in the numbers, thicknesses, and composition of the concentric layers. Furthermore, adding additional layers or changing other design parameters may produce more variations. The conductor may or may not be twisted. If glass tape layers are used, they may be coated and wrapped at top, bottom or middle of the layers. The coatings may be comparatively thick or thin. Ceramifiable polymer layers may be on top, bottom or middle. High temperature glass, quartz, ceramic tape, etc. May be used in the outer layer or any part of construction, but preferably is used to encapsulate lower softening point materials like glass etc. The metal outer sheath may be metal foil or a thin walled tube or metal braid, which may be put inside a second sheath, so that there is a shell within a shell.

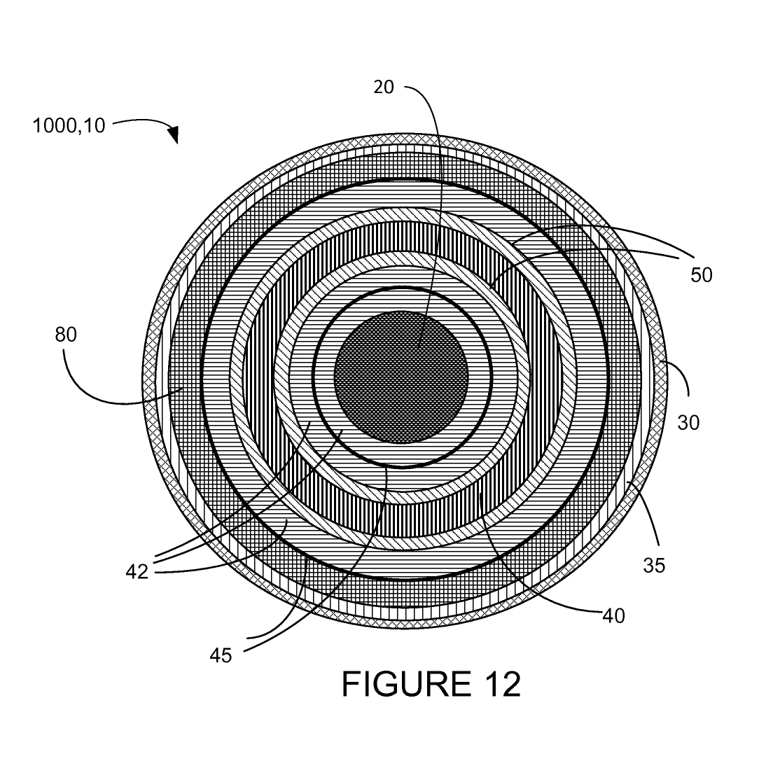

FIG. 12 shows a tenth embodiment 1000, in which a central conductor 20, is surrounded by a layer of dielectric material 42 such as glass tape or dielectric tape, either of which can be either plain or woven, which then includes a coating 45, of inorganic material such as titanium diboride, alumina, alumina-silica, BN, silicon carbide, yttrium oxide, zirconium oxide, MgO or any other ceramic or refractory material that can be coated onto the dielectric tape layer 42. This is followed by a second layer of dielectric tape 42. This is followed by a layer of ceramifiable polymer 50, followed by several layers of glass/mica 40. Then a second layer of ceramifiable polymer, followed by another layer of dielectric tape 42, which may also be coated 45. This is surrounded by a layer of high temperature glass, quartz or ceramic tape 80. This high temperature glass, quartz, etc. 80 has a much higher softening point than glass 40 used in the previous layers and therefore is used to encapsulate the glass 40. It is also possible to use these high temperature materials 80 and coat them with inorganic materials 45 discussed above but it is preferred to use glass 40 and then enclose it with high temperature materials 80. This is followed by a layer of metal foil 35, which can be a plain tube, or braided, and finally a metal sheath 30 to complete the embodiment 1000. It should be noted that the layers shown are not to scale, may be re-ordered or re-arranged and the number of layers may be varied as needed. As discussed before, many variations are possible, but they include coated wire and tapes that enhance the dielectric properties of the composite and usage of high temperature tapes, braids, coverings, etc. to encapsulate the construction.

It is also possible to combine the completed embodiments of heater wires in many different ways. Three heater wires can be configured within a metal sheath, with each of the three conductor wires attached to a different phase wire with the metal sheath acting as the return path for the circuit to make a three-phase system. Thus each phase can be powered at a voltage, and thereby increase the overall length of the circuit. This is only possible when the insulation package can withstand high voltages and temperatures.

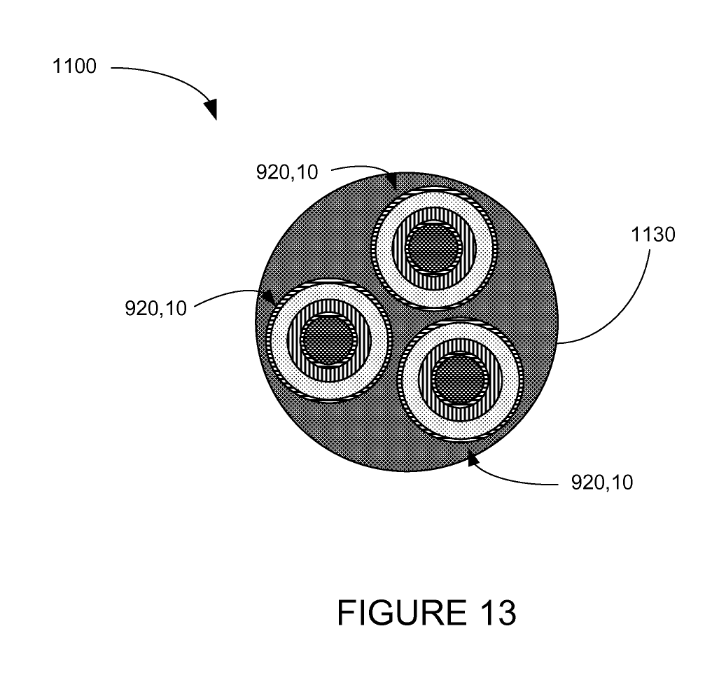

FIG. 13 shows one such configuration of heater wires 10, in this case, the ninth embodiment discussed above, embodiment 900, to make a three-phase system 1100. Reference is made also to FIG. 11, in which a central conductor 20, is surrounded by a layer of semi-conductive material 70, a concentric layer of glass/mica insulator 40, a concentric layer of MgO or other non-conductive inorganic material 60 such as ceramic powders, and a second layer of semi-conductive material 70, which are then enclosed in a metal sheath 30 to complete the ninth embodiment 900. Three heater wires of the ninth embodiment configuration 900 can be configured within another metal sheath 1130, with each of the three conductor wires 20 attached to a different phase wire with the metal sheath 1130 acting as the return path for the circuit. The metal sheath 30 for each of the individual wires is preferably not included, as shown in FIG. 13, in favor of the metal sheath 1130 which encloses the entire 3-phase structure 1100. The ninth embodiments without the individual sheaths is designated by the element number 920 in FIG. 13.

In fact, any one of the previously described embodiments or variations thereof could be used to make the three-phase system 1100. Since three heaters are in close proximity, the insulation package has to be capable of withstanding high temperature and voltages.

It is also possible that some of these unique configurations of insulation can be used with existing wiring, which is not high temperature and high voltage resistant in itself, to make this existing wiring more suitable for these high temperature/voltage applications. A crucial and typical breakdown mode for high temperature and high voltage applications is breakdown of the insulation so that electrical shorts then occur. If an improved insulation package can be installed around these wires, massive replacement of existing wires may not be necessary.

It may also be desirable to splice or join several wires together to create longer lengths. These interfaces where the wires are joined together are typically spots where electrical leakage may occur causing dangerous shorts. It is therefore desirable to have an insulation sleeve, which can be used at the join where the two wires are welded or crimped or somehow physically joined together. These sleeves must also be capable of withstanding high temperatures and voltages and may thus be configured in a similar manner as the concentric layers of insulation discussed in regard to the heater cables above, but are configured without the central conductor. The two ends of the wire to be joined are inserted into the sleeve, mechanically joined by heating or crimping, and the sleeve positioned covering the two now joined ends, so the join is surrounded by the insulation layers of the sleeve.

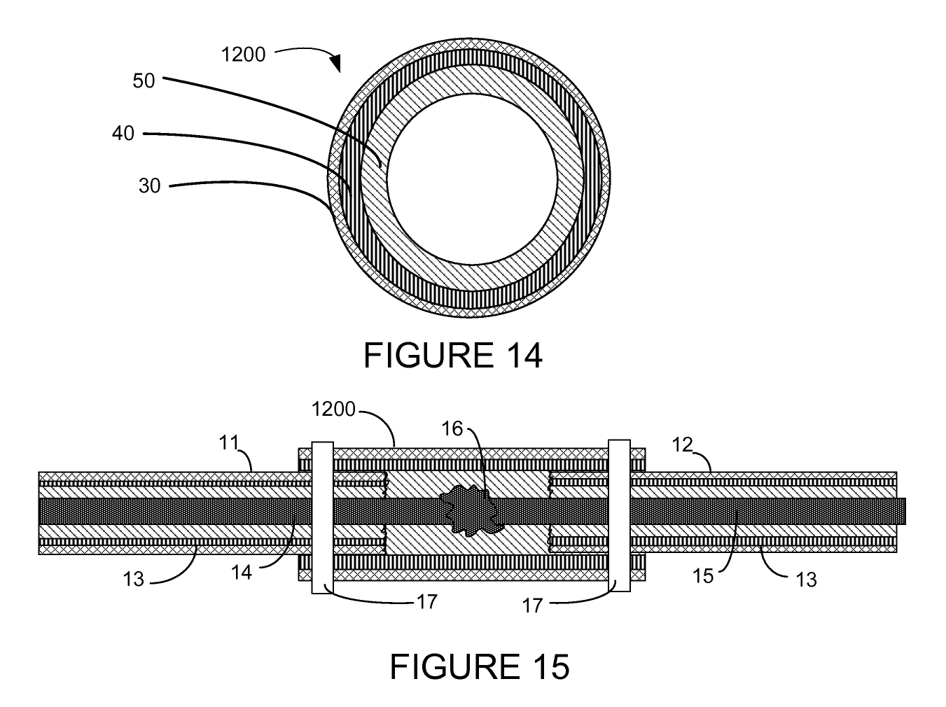

FIG. 14 shows a cross-section of one such insulator sleeve 1200 with a structure which is typical, but not to be taken as a limitation. Any one of the previously described embodiments with different layers can be used as long as they match the heaters and/or application, when made of appropriate diameter and with the central conductor removed. For this example, the sleeve 1200 resembles the second embodiment 200 discussed previously and shown in FIG. 4. A layer of glass/mica insulator 40 surrounds a concentric layer of ceramifiable polymer 50. A metal sheath 30 encloses these layers.

FIG. 15 shows a first heater wire 11 and a second heater wire 12 which have been joined together to repair or extend their length. This is done by stripping the insulation 13 to expose the first conductor 14 and the second conductor 15. The insulator sleeve 1200 is of the appropriate diameter that it can be slipped onto one of the wires 11, 12. The conductors 14, 15 are crimped or welded together at a weld 16. The sleeve 1200 is then moved into place covering the weld 16, and held in place by mechanical ties 17.

The insulation 13 is shown in FIG. 15 to be the same composition as the example sleeve 1200 in FIG. 14, but this is not a requirement, and in fact may be of a completely different composition.

In fact, the sleeve 1200 may be extensive in length and used to cover a considerable length of conventional wire thus providing it with the high voltage and heat resistance of the present heating wires. This allows conventional wires to be retro-fit with the high voltage and temperature advantages of the present heater wires.

The sleeve 1200 may also be configured in an internal hour-glass shape, such that the insulation thickness is maximum at the conductor joint and progressively gets smaller as it approaches the ends of the sleeve. This may enable the repaired section to maintain a similar diameter to the original wire when completed.

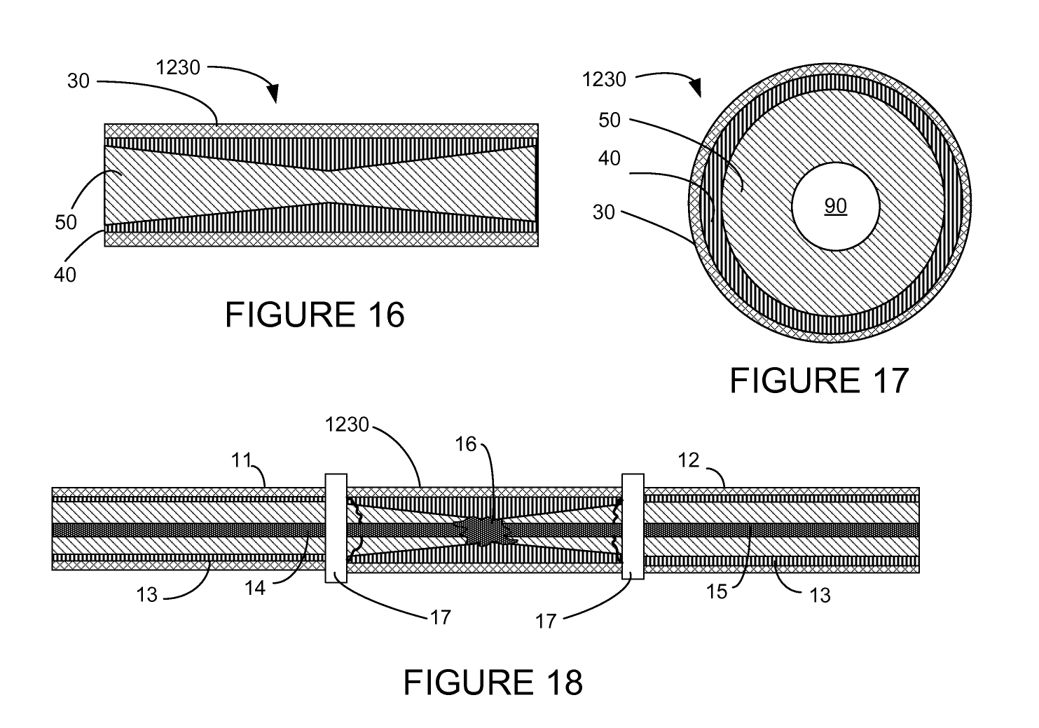

A shaped sleeve 1230 is shown in longitudinal cross-section in FIG. 16, and in cross section in FIG. 17. The shaped sleeve 1230 again has the same layers of glass/mica insulator 40 surrounding a concentric layer of ceramifiable polymer 50, and a metal sheath 30 enclosing these layers. Again, this configuration is used as example and many other previously described embodiments may be used. The central opening 90 is configured to fit the conductor wires 14, 15 at its smallest diameter at the longitudinal center of the sleeve, but this diameter of the central opening 90 varies along the length, becoming larger near the ends.

FIG. 18 again shows a first heater wire 11 and a second heater wire 12 which have been joined together by stripping the insulation 13 to expose the first conductor 14 and the second conductor 15. The conductors 14,15 are crimped or welded together at a weld 16. The shaped sleeve 1230 is positioned surrounding the weld. The materials of construction are somewhat compressible and therefore may be able to slide over bigger diameter and create clearance enough to be able to join the wires and then move back the sleeve in position and held in place by mechanical ties 17.

It is to be understood that there is considerable variation possible in the configuration and the true scope of the invention is to be limited by the claims which will be presented in the non-provisional application.

### INDUSTRIAL APPLICABILITY

The present invention is a high voltage, high temperature heating cable, which is well suited for heating long pipes, especially pipes which carry oil or other fluids for which low viscosity induced by elevated temperatures is important to increase material flow. These long line, high voltage, high temperature heaters are especially suited for delivering high watts to the rock formation or soil that may carry Bituman, Kerogen, high fuel value gases etc. and thus release these products when heated properly and economically.

Increasingly, off-shore drilling and some very deep on-shore drilling are used to access previously inaccessible areas, which require special equipment. As with most liquids, the viscosity of crude oil varies with temperature, and becomes less viscous at higher temperatures, so it may be necessary to heat some of the equipment and/or pipes in order to efficiently extract the material or to keep the material flowing in a pipe. Therefore, it may be necessary to heat the material, or the pipes themselves, at very high temperatures, greater than 600° c. To keep the material flowing properly. Some of these applications require products that can generate high power, e.g. Watts, at these high temperatures. Since deposits tend to be deep in the ground, perhaps tens of thousands of feet deep, high input voltage is required to be able to generate adequate power at these depths in a safe and efficient manner. That means the package for a heating device needs to have a tough and usable insulation package with good dielectric properties at both high temperatures, and high voltages.

Suitable applications for these heating devices are in off-shore, or on-shore long line heaters, used when drilling deep under the surface to extract bituman or converting kerogen in the rocks to pumpable oil. An important application is in the tar sands in Canada and tag SAGD (Steam Assisted Gravity Drainage) in U.S./Canada or for down hole heating to reduce viscosity of oil to help flow characterics and improve pumpability of oil. The present invention, which uses materials which have improved dielectric properties may be used for high voltage and/or high temperature applications. These applications may include long line heaters requiring very high voltages and temperatures to maintain temperature of fluid in pipes or to reduce viscosity of the fluid to improve flow characteristics. The present invention improves on existing heater systems by providing enhanced insulation with better thermal and voltage properties. The present invention can withstand high voltage and thus can be powered over very long lengths and provide high power at higher temperatures at longer lengths than is possible with the previous devices such as sect heating (skin effect heating system), a current leader in the field. This system may also be used as insulation for medium tension cables in Wire & Cable industry or any other industrial application requiring high temperatures or voltages.

There are several aspects to the present invention, which provide advantages over the prior art, concerning several important variables.

First, concerning the current carrying conductor, the present invention preferably, but not necessarily, uses multiple conductors of smaller diameter which together to produce a composite resistance with the same or higher than the single conductor in MI on a per foot basis. This configuration makes the cable less rigid, and more flexible. These multiple conductors may be twisted together in a spiral configuration, having a pitch preferably in the range of 8× equivalent diameter of the conductor bundle to 14× equivalent diameter of the conductor bundle. This preferred pitch range gives high resistance that can be used at very high voltage, while maintaining good flexibility. This configuration of pitch and flexibility is the product of considerable experience and experimentation, and is assertedly novel in itself. There are several aspects to the present invention, which provide advantages over the prior art, concerning several important variables.

Also, the present inventor has found that different size conductors may be twisted together or combinations of different alloys with different thermal and/or electrical properties may be twisted together to produce unique wattage responses.

Twisting of conductors may also be utilized to include sensor wires in the cable bundle to generate and access live data.

Concerning the variable of insulation, prior product MI cables generally utilize MgO (magnesium oxide powder) as an insulator around a central conductor with a certain resistance/ft. Generally, the package is put inside a metallic tube and whole assembly is drawn or swaged such that the powder compacts around the conductor. The conductor and the sheath are also drawn such that the thickness of the tube and the conductor is reduced to meet resistance and diameter specs. With powder used as a filler and in thicknesses required to be effective as a dielectric, the heater becomes very rigid and difficult to bend.

In contrast to these conventional prior cables, which generally use MgO (magnesium oxide powder) as an insulation, some embodiments of the present invention use mica/glass tape composite wrapped around the central conductor to use as insulation. Depending upon the design requirements, the present invention may use layers of glass tape and layers of mica tape to required thickness to achieve the proper dielectric properties for the cable. By changing these layers, these cables can be configured to operate at very high voltages. Also since the tapes are flexible the whole cable becomes flexible even when inside a metal sheath, which is a distinct advantage over prior cables.

MgO and other materials (alone or as powder mixtures or as pre-fab ceramics rings, tubes etc.) can be configured as a small layer inside and or outside the mica/glass package encased in a metal tube, slightly drawn or swaged to compress and compact the powder and mica/glass package. This gives rugged yet relatively flexible heating cable that can be used at very high temperatures, and very high voltages.

Another embodiment of the present invention uses layers of flexible coatings of ceramifiable polymers, including ceramifiable silicones on conductor and or layers in-between or outside of mica/glass insulation package. This can boost dielectric properties at lower temperatures, and adds to dielectric properties of the total composite at higher temperatures.

Thus, improved insulation used on a single or multi-strand conductors in combination or separate insulation packages can provide enhanced thermal, dielectric and mechanical properties for the cable not provided by any other system available

Ceramifiable polymers may be loosely defined as organic polymers which solidify at high temperatures to produce refractory ceramics. These may be extruded on to the conductor and then mica/glass layers wrapped on the conductor/silicone composite as described above. Silicone may also be extruded or laminated on glass or mica tape and then the resulting tape wrapped on the conductor or mica/glass composite as appropriate. An important advantage of putting a silicone layer on glass or mica tape is that it fills up the air voids thereby increasing the dielectric properties of the insulation without major change in thickness.

Embodiments of the present invention use sheath material which may be metal or alloy tube as appropriate for the application. The sheath can also be a metal corrugated hose for flexibility especially when package does not have to be drawn or swaged.

A first embodiment 100 of the present heater cable 10 includes a central conductor 20, which may be a multi-strand conductor 22, and further may be a twisted multi-strand conductor 24. The number of strands is preferred to be in the range of 2 to 20 strands, but there may be more. A concentric layer or a number of layers of glass/mica insulator 40 surrounds the conductor 20. These layers of glass/mica insulator 40 preferably include layers of glass tape and layers of mica tape, which are wound around the central conductor 20. A metal sheath 30 encloses these layers to complete the embodiment 100.

A second embodiment 200 of the present heater cable 10 includes a central conductor 20, which again may be a twisted multi-strand conductor, which is not shown in the following figures, but will be understood to be an option in this and in all the following embodiments. A concentric layer of ceramifiable polymer 50 surrounds the conductor 20, which in turn is surrounded by a layer of glass/mica insulator 40. A metal sheath 30 encloses these layers to complete the embodiment 200.

A third embodiment 300 of the present heater cable 10 includes a central conductor 20, which again may be a multi-strand conductor. A concentric layer of MgO or non-conductive inorganic material 60 such as ceramic powders and inorganic ceramic/glass alloys is surrounded by ceramifiable polymer 50, which in turn is surrounded by a layer of glass/mica insulator 40. A metal sheath 30 encloses these layers to complete the embodiment 300. It will be understood that non-conductive inorganic ceramic/glass alloys will include, but are not limited to Al₂O₃, TlO₂, SiO₂, B₂O₃, MgO, and BeO.

A fourth embodiment 400 of the present heater cable 10 includes a central conductor 20, which again may be a multi-strand conductor. A concentric layer of MgO or non-conductive inorganic material 60 such as ceramic powders and ceramic/glass alloys is surrounded by a layer of glass/mica insulator 40. A metal sheath 30 encloses these layers.

It is also possible that ceramifiable polymers may be used as an inside layer or an outside layer or both. A fifth embodiment 500 of this type, includes the layers of a central conductor 20, concentric layer of MgO or other non-conductive inorganic material 60 such as ceramic powders, a concentric layer of ceramifiable polymer 50, a concentric layer of glass/mica insulator 40, and an added outer layer of ceramifiable polymer 50, which are enclosed in a metal sheath 30.

A sixth embodiment 600 includes layers of a central conductor 20, concentric layer of MgO or other non-conductive inorganic material 60 such as ceramic powders, a concentric layer of glass/mica insulator 40, and an added outer layer of ceramifiable polymer 50, which are enclosed in a metal sheath 30.

It is also possible that MgO or other non-conductive ceramic powders may be used as an inside layer or an outside layer or both. A seventh embodiment 700 includes the same layers of a central conductor 20, concentric layer of MgO or other non-conductive inorganic material 60 such as ceramic powders, a concentric layer of ceramifiable polymer 50, a concentric layer of glass/mica insulator 40, and an added outer layer of MgO or other non-conductive inorganic material 60 such as ceramic powders, which are enclosed in a metal sheath 30.

An eighth embodiment 800 includes layers of a central conductor 20, concentric layer of MgO or other non-conductive inorganic material 60 such as ceramic powders, a concentric layer of glass/mica insulator 40, and an added outer layer of MgO or other non-conductive inorganic material 60 such as ceramic powders, which are enclosed in a metal sheath 30.

Layers of semi-conductive material may also be included in the structure of the cables. These semi-conductive layers may be extruded on to the substrates or coated via dip coating or sputtering on to substrates. The coating materials may be conductive polymers, conductive ceramics and/or combination of the two and deposited on the surfaces to be coated. Conductive polymers may be intrinsically conductive and /or made conductive via mixing with substances including, but not limited to CB, graphite, conductive ceramics like NBO, TiO, CrO₂, Ti₂O₃, VO, V₂O₃, and iron oxide. Barium titanate may also be used as a semi-conductive layer.

A ninth embodiment 900 includes a central conductor 20 surrounded by a layer of semi-conductor material 70, a concentric layer of glass/mica insulator 40, a concentric layer of MgO or other non-conductive inorganic material 60 such as ceramic powders, and a second layer of semi-conductor material 70, which are then enclosed in a metal sheath 30.

It should be understood that there could be variations that include only one or the other of these semi-conductor layers, and that other configurations of these layers are intended to be included in this invention.

It is also possible that one or more of the layers be made of positive temperature coefficient (PTC) material, negative temperature coefficient (NTC) material, or zero temperature coefficient (ZTC) material.

It has been found that it is very effective to make use of coatings of inorganic materials which are coated onto various components of the construction and which may be repeated at various stages of the construction, if desired. These coatings tend to provide a more continuous layer of di-electric material than can be produced by compressed powder. These coatings thus produce better high voltage performance. Coatings of the substrates may be applied by the relatively simple processes already known in the coating art like dip-coating, extrusion coating, spray coating, lamination, brush coating, sputtering and/or evaporation films, followed by processing to dry and cure the coating as required by the materials of choice and process.

As in the previous discussion, the conductor may be stranded or solid construction, which may then be coated with high temperature refractory coatings like CP 3015-wh from Aremco Co. The choice of coatings is dictated by the adhesion to substrate, thickness, temperature, capability and voltage response, among other considerations.

Whether the conductor is coated or not, other substrates may be coated with high temperature refractory coatings to increase the thermal and voltage performance. For example, glass tape or quartz, high temperature glass, ceramic tape, etc. After winding on the conductor may be coated with 634-AS-1 from Aremco Co. By dip coating or other means as mentioned above, dried and followed by layers of mica, glass, etc., as the design requires.

These coatings may be several mils thick and may be applied several times as needed or physically possible. The purpose is to increase the dielectric properties of the layered package for various applications. These coatings may be based on titanium diboride, alumina, alumina-silica, BN, SiC, yttrium oxide, zirconium oxide, MgO and any other ceramic or refractory that can be made into a stable slurry that is coatable.

As referred to above, many variations are possible in the numbers, thicknesses, and composition of the concentric layers. Furthermore, adding additional layers or changing other design parameters may produce more variations. The conductor may or may not be twisted. If glass tape layers are used, they may be coated and wrapped at top, bottom or middle of the layers. The coatings may be comparatively thick or thin. Ceramifiable polymer layers may be on top, bottom or middle. High temperature glass, quartz, ceramic tape, etc. May be used in the outer layer or any part of construction, but preferably is used to encapsulate lower softening point materials like glass etc. The metal outer sheath may be metal foil or a thin walled tube or metal braid, which may be put inside a second sheath, so that there is a shell within a shell.

A tenth embodiment 1000 includes a central conductor 20 surrounded by a layer of dielectric material 42 such as glass tape or dielectric tape, either of which can be either plain or woven, which then includes a coating 45, of inorganic material such as titanium diboride, alumina, alumina-silica, BN, silicon carbide, yttrium oxide, zirconium oxide, MgO or any other ceramic or refractory material that can be coated onto the dielectric tape layer 42. This is followed by a second layer of dielectric tape 42. This is followed by a layer of ceramifiable polymer 50, followed by several layers of glass/mica 40. Then a second layer of ceramifiable polymer, followed by another layer of dielectric tape 42, which may also be coated 45. This is surrounded by a layer of high temperature glass, quartz or ceramic tape 80. This high temperature glass, quartz, etc. 80 has a much higher softening point than glass 40 used in the previous layers and therefore is used to encapsulate the glass 40. It is also possible to use these high temperature materials 80 and coat them with inorganic materials 45 discussed above but it is preferred to use glass 40 and then enclose it with high temperature materials 80. This is followed by a layer of metal foil 35, which can be a plain tube, or braided, and finally a metal sheath 30 to complete the embodiment 1000. It should be noted that the layers may be re-ordered or re-arranged and the number of layers may be varied as needed. As discussed before, many variations are possible, but they include coated wire and tapes that enhance the dielectric properties of the composite and usage of high temperature tapes to encapsulate the construction.

It is also possible to combine the completed embodiments of heater wires in many different ways. Three heater wires can be configured within a metal sheath, with each of the three conductor wires attached to a different phase wire with the metal sheath acting as the return path for the circuit to make a three-phase system. Thus each phase can be powered at a voltage, and thereby increase the overall length of the circuit. This is only possible when the insulation package can withstand high voltages and temperatures.

Any one of the previously described embodiments or variations thereof could be used to make the three-phase system 1100. Since three heaters are in close proximity, the insulation package has to be capable of withstanding high temperature and voltages.

It is also possible that some of these unique configurations of insulation can be used with existing wiring, which is not high temperature and high voltage resistant in itself, to make this existing wiring more suitable for these high temperature/voltage applications. A crucial and typical breakdown mode for high temperature and high voltage applications is breakdown of the insulation so that electrical shorts then occur. If an improved insulation package can be installed around these wires, massive replacement of existing wires may not be necessary.

It may also desirable to splice or join several wires together to create longer lengths. These interfaces where the wires are joined together are typically spots where electrical leakage may occur causing dangerous shorts. It is therefore desirable to have an insulation sleeve, which can be used at the join where the two wires are welded or crimped or somehow physically joined together. These sleeves must also be capable of withstanding high temperatures and voltages and may thus be configured in a similar manner as the concentric layers of insulation discussed in regard to the heater cables above, but are configured without the central conductor. The two ends of the wire to be joined are inserted into the sleeve, mechanically joined by heating or crimping, and the sleeve positioned covering the two now joined ends, so the join is surrounded by the insulation layers of the sleeve.

Any one of the previously described embodiments with different layers can be used as long as they match the heaters and/or application, when made of appropriate diameter and with the central conductor removed. For example, the sleeve 1200 resembles the second embodiment 200 discussed previously. A layer of glass/mica insulator 40 surrounds a concentric layer of ceramifiable polymer 50. A metal sheath 30 encloses these layers.

When a first heater wire 11 and a second heater wire 12 which have been joined together to repair or extend their length, this is done by stripping the insulation 13 to expose the first conductor 14 and the second conductor 15. The insulator sleeve 1200 is of the appropriate diameter that it can be slipped onto one of the wires 11, 12. The conductors 14, 15 are crimped or welded together at a weld 16. The sleeve 1200 is then moved into place covering the weld 16, and held in place by mechanical ties 17.

The insulation 13 may be the same composition as the example sleeve 1200, but this is not a requirement, and in fact may be of a completely different composition.

In fact, the sleeve 1200 may be extensive in length and used to cover a considerable length of conventional wire thus providing it with the high voltage and heat resistance of the present heating wires. This allows conventional wires to be retro-fit with the high voltage and temperature advantages of the present heater wires.

The sleeve 1200 may also be configured in an internal hour-glass shape, such that the insulation thickness is maximum at the conductor joint and progressively gets smaller as it approaches the ends of the sleeve. This may enable the repaired section to maintain a similar diameter to the original wire when completed.

A shaped sleeve 1230 discussed above has the same layers of glass/mica insulator 40 surrounding a concentric layer of ceramifiable polymer 50, and a metal sheath 30 enclosing these layers. Again, this configuration is used as example and many other previously described embodiments may be used. The central opening 90 is configured to fit the conductor wires 14, 15 at its smallest diameter at the longitudinal center of the sleeve, but this diameter of the central opening 90 varies along the length, becoming larger near the ends.

In use, a first heater wire 11 and a second heater wire 12 can be joined together by stripping the insulation 13 to expose the first conductor 14 and the second conductor 15. The conductors 14, 15 are crimped or welded together at a weld 16. The shaped sleeve 1230 is positioned surrounding the weld. The materials of construction are somewhat compressible and therefore may be able to slide over bigger diameter and create clearance enough to be able to join the wires and then move back the sleeve in position and held in place by mechanical ties 17.

For the above, and other, reasons, it is expected that the various embodiments of the high temperature high voltage cables of the present invention will have widespread industrial applicability. Therefore, it is expected that the commercial utility of the present invention will be extensive and long lasting.

1. A high temperature, high voltage cable having multiple layers comprising:
at least one multi-strand conductor whose resistance is controlled by tightness or looseness of pitch;
an insulation layer; and
a sheath, wherein the pitch of said multi-strand conductor lies within the range of 8× equivalent diameter of bundle of conductors to 14× equivalent diameter of bundle of conductors.

2. A high temperature, high voltage cable having multiple layers comprising:
at least one conductor:
at least one layer of ceramifiable polymer; and
at least one layer of mica/glass.

3. The high temperature, high voltage cable of claim 2, wherein said ceramifiable polymer is chosen from a group consisting of ceramifiable silicones, pre-ceramic polymers, and ceramifiable silazanes.

4. The high temperature, high voltage cable of claim 2, further comprising at least one layer of non-conductive inorganic material.

5. The high temperature, high voltage cable of claim 4, wherein said layer of non-conductive inorganic material is chosen from a group consisting of AL₂O₃, TiO₂, SiO₂, B₂O₃, MgO, and BeO, BN,Zirconia,macor(glass-ceramic), Aluminum nitride, BN-AlN composite, and Alumina-silica, yttrium oxide.

6. The high temperature, high voltage cable of claim 2, further comprising at least one layer of semiconductive material.

7. The high temperature high voltage cable of claim 6 wherein said semiconductive material is chosen from a group consisting of conductive materials including conductive polymers mixed with CB, graphite, conductive ceramics, and inorganic conductive material including NBO, TiO, CrO₂, Ti₂O₃, VO, V₂O₃, iron oxide and Barium titanate.

8. The high temperature, high voltage cable of claim 2, further comprising at least one layer of dielectric material chosen from a group consisting of glass, ceramic, silica, and quartz.

9. The high temperature, high voltage cable of claim 2, further comprising at least one coating of high temperature tape material chosen from a group consisting of high temperature glasstape, quartz tape, ceramic tape, and silica tape.

10. The high temperature, high voltage cable of claim 2, further comprising at least one coating of metal foil material chosen from a group consisting of copper, nickle, nickle alloys, titanium, steel, stainless steel, and incoloy.

11. The high temperature, high voltage cable of claim 2, further comprising at least one multistrand conductor.

12. The high temperature, high voltage cable of claim 11, wherein said at least one multi-strand conductor is a three-phase system.

13. A high temperature, high voltage cable having multiple layers comprising:
at least one conductor:
at least one layer of non-conductive inorganic material; and
at least one layer of mica/glass tape.

14. The high temperature, high voltage cable of claim 13, wherein said layer of non-conductive inorganic material is chosen from a group consisting of AL₂O₃, TiO₂, SiO₂, B₂O₃, MgO, BeO, BN, Zirconia, macor(glass-ceramic), Aluminum nitride, BN-AlN composite, Alumina-silica, and Ytrium oxide.

15. The high temperature, high voltage cable of claim 13, further comprising at least one layer of ceramifiable polymer.

16. The high temperature, high voltage cable of claim 15, wherein said ceramifiable polymer is chosen from a group consisting of ceramifiable silicones, pre-ceramic polymers, and ceramifiable silazanes.

17. The high temperature, high voltage cable of claim 13, further comprising at least one layer of semiconductive material chosen from a group consisting of conductive materials including conductive polymers mixed with CB, graphite, conductive ceramics and inorganic conductive materials including NBO, TiO, CrO₂, Ti₂O₃, VO, V₂O₃, iron oxide and Barium titanate.

18. The high temperature, high voltage cable of claim 13, further comprising at least one layer of dielectric material chosen from a group consisting of glass, ceramic, silica, and quartz.

19. The high temperature, high voltage cable of claim 13, further comprising at least one coating of high temperature tape material chosen from a group consisting of high temperature glass tape, quartz tape, ceramic tape, and silica tape.

20. The high temperature, high voltage cable of claim 13, further comprising at least one coating of metal foil material chosen from a group consisting of copper, nickle, nickle alloys, titanium, steel, stainless steel, and incoloy.

21. The high temperature, high voltage cable of claim 13, further comprising at least one multistrand conductor.

22. The high temperature, high voltage cable of claim 21, wherein said at least one multi-strand conductor is a three-phase system.

23. A high temperature, high voltage sleeve having multiple layers comprising
at least one layer of ceramifiable polymer; and
at least one layer of mica/glass

24. A high temperature, high voltage sleeve having multiple layers comprising
at least one layer of non-conductive inorganic material; and
at least one layer of mica/glass.

25. A heating cable comprising:
at least one conductor;
at least one layer of mica/glass; and
at least one layer of thermally conductive and electrically insulating inorganic materials chosen from a group consisting of BN, MgO, Al2O3, and SiO2,TiO2, B2O3, BeO,Zirconia,Macor(glass-ceramic),AlN,BN-AlN,Alumina-Silica, and Yttrium oxide.

26. The heating cable of claim 25 further comprising;
at least one layer of ceramifiable polymer.

27. A flexible heating cable comprising:
at least one stranded conductor; and
at least one layer of flexible mica/glass tape that is coated with thermally conductive and electrically insulating material chosen from a group consisting of BN, MgO, Alumina, Silica, TiO2, B2O3, BeO, Zirconia, Macor (glass-ceramic), AN, BN-AlN, Alumina-Silica, and Yttrium oxide.
